(19) United States
(12) Patent Application Publication
(10) Pub. No.: US 2025/0110245 A1
(43) Pub. Date: Apr. 3, 2025

(54) ENHANCED GNSS MEASUREMENT HANDLING IN REAL-TIME KINEMATIC (RTK) AND PRECISE POINT POSITIONING (PPP)

(71) Applicant: QUALCOMM Incorporated, San Diego, CA (US)

(72) Inventors: Furqan AHMED, Eastvale, CA (US); Yuxiang PENG, San Jose, CA (US); Ning LUO, Cupertino, CA (US)

(21) Appl. No.: 18/782,323

(22) Filed: Jul. 24, 2024

Related U.S. Application Data
(60) Provisional application No. 63/586,282, filed on Sep. 28, 2023.

(51) Int. Cl. G01S 19/40; G01S 19/39; G01S 19/43

(52) U.S. Cl. CPC G01S 19/40; G01S 19/396; G01S 19/43

(57) ABSTRACT

A global navigation satellite system (GNSS) device may receive GNSS correction data and may determine a respective standard deviation of pre-fit residuals of one or more GNSS measurement types of a set of GNSS measurements. The GNSS device may determine at least one conditional trigger is met based on a comparison of the respective standard deviation of pre-fit residuals of the one or more GNSS measurement types with a respective threshold, and, responsive to determining the at least one conditional trigger is met, may modify how a positioning engine processes one or more measurements of the set of GNSS measurements. The GNSS device may determine a position estimate of the GNSS device based at least in part on a result of the modified processing of the one or more measurements by the positioning engine and the GNSS correction data.

### RELATED APPLICATIONS

This application claims the benefit of U.S. Provisional Application No. 63/586,282, filed Sep. 28, 2023, entitled “ENHANCED GNSS MEASUREMENT HANDLING IN RTK/PPP,” which is assigned to the assignee hereof, and incorporated herein in its entirety by reference.

### BACKGROUND

The present disclosure generally relates to the field of satellite-based positioning and, more specifically, to Global Navigation Satellite Systems (GNSS) positioning.

Precise positioning techniques such as real-time kinematic (RTK) and precise point positioning (PPP) can enhance the precision of a position estimate obtained by a Global Navigation Satellite Systems (GNSS) receiver. The sub-meter-level position estimates that precise positioning can provide typically exceed the accuracy of traditional consumer-grade GNSS receivers. Thus, precise positioning can increase the number of applications that consumer-grade GNSS receivers may be used for. The precision of such positioning solutions, however, can be greatly affected by GNSS measurements subject to multipath and/or other challenging conditions that can degrade GNSS measurement quality.

### BRIEF SUMMARY

An example method of global navigation satellite system (GNSS) measurement handling for precise positioning of a GNSS device, according to this disclosure, may comprise receiving, at the GNSS device, GNSS correction data from a correction data source. The method also may comprise determining, for a set of GNSS measurements performed by the GNSS device and corresponding to a measurement epoch, a respective standard deviation of pre-fit residuals of one or more GNSS measurement types of the set of GNSS measurements, the one or more GNSS measurement types comprising: pseudorange (PR) measurements, carrier phase (CP) measurements, Doppler (DR) measurements, or any combination thereof. The method also may comprise determining at least one conditional trigger is met based on a comparison of the respective standard deviation of pre-fit residuals of the one or more GNSS measurement types with a respective threshold. The method also may comprise, responsive to determining the at least one conditional trigger is met, modifying how a positioning engine processes one or more measurements of the set of GNSS measurements. The method also may comprise determining a position estimate of the GNSS device based at least in part on a result of the modified processing of the one or more measurements by the positioning engine and the GNSS correction data.

An example GNSS device for global navigation satellite system (GNSS) measurement handling for precise positioning of a GNSS device, according to this disclosure, may comprise one or more transceivers, one or more memories, one or more processors communicatively coupled with the one or more transceivers and the one or more memories, wherein the one or more processors are configured to receive, via the one or more transceivers, GNSS correction data from a correction data source. The one or more processors further may be configured to determine, for a set of GNSS measurements performed by the GNSS device and corresponding to a measurement epoch, a respective standard deviation of pre-fit residuals of one or more GNSS measurement types of the set of GNSS measurements, the one or more GNSS measurement types comprising: pseudorange (PR) measurements, carrier phase (CP) measurements, Doppler (DR) measurements, or any combination thereof. The one or more processors further may be configured to determine at least one conditional trigger is met based on a comparison of the respective standard deviation of pre-fit residuals of the one or more GNSS measurement types with a respective threshold. The one or more processors further may be configured to, responsive to determining the at least one conditional trigger is met, modifying how a positioning engine processes one or more measurements of the set of GNSS measurements. The one or more processors further may be configured to determine a position estimate of the GNSS device based at least in part on a result of the modified processing of the one or more measurements by the positioning engine and the GNSS correction data.

An example apparatus for global navigation satellite system (GNSS) measurement handling for precise positioning of a GNSS device, according to this disclosure, may comprise means for receiving GNSS correction data from a correction data source. The apparatus further may comprise means for determining, for a set of GNSS measurements performed by the GNSS device and corresponding to a measurement epoch, a respective standard deviation of pre-fit residuals of one or more GNSS measurement types of the set of GNSS measurements, the one or more GNSS measurement types comprising: pseudorange (PR) measurements, carrier phase (CP) measurements, Doppler (DR) measurements, or any combination thereof. The apparatus further may comprise means for determining at least one conditional trigger is met based on a comparison of the respective standard deviation of pre-fit residuals of the one or more GNSS measurement types with a respective threshold. The apparatus further may comprise means for, responsive to determining the at least one conditional trigger is met, modifying how a positioning engine processes one or more measurements of the set of GNSS measurements. The apparatus further may comprise means for determining a position estimate of the GNSS device based at least in part on a result of the modified processing of the one or more measurements by the positioning engine and the GNSS correction data.

According to this disclosure, an example non-transitory computer-readable medium stores instructions for global navigation satellite system (GNSS) measurement handling for precise positioning of a GNSS device, the instructions comprising code for receiving, at the GNSS device, GNSS correction data from a correction data source. The instructions further may comprise code for determining, for a set of GNSS measurements performed by the GNSS device and corresponding to a measurement epoch, a respective standard deviation of pre-fit residuals of one or more GNSS measurement types of the set of GNSS measurements, the one or more GNSS measurement types comprising: pseudorange (PR) measurements, carrier phase (CP) measurements, Doppler (DR) measurements, or any combination thereof. The instructions further may comprise code for determining at least one conditional trigger is met based on a comparison of the respective standard deviation of pre-fit residuals of the one or more GNSS measurement types with a respective threshold. The instructions further may comprise code for, responsive to determining the at least one conditional trigger is met, modifying how a positioning engine processes one or more measurements of the set of GNSS measurements. The instructions further may comprise code for determining a position estimate of the GNSS device based at least in part on a result of the modified processing of the one or more measurements by the positioning engine and the GNSS correction data.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified diagram of a GNSS system, according to an embodiment.

FIG. 2 is an illustration of related graphs provided to show an example of the correlation between pre-fit residuals of pseudorange (PR) and horizontal error (HE) of an RTK solution.

FIG. 3 is a block diagram of a method of handling GNSS measurements for RTK/PPP positioning using adaptive and/or hybrid Receiver Autonomous Integrity Monitoring (RAIM), according to an embodiment.

FIG. 4 is a block diagram of how certain operations related to the adaptive RAIM portrayed in FIG. 3 may be implemented, according to some embodiments.

FIG. 5 is an illustration of experimental results of implementing adaptive RAIM in the manner illustrated in FIG. 4.

FIG. 6 is a block diagram of how certain operations related to hybrid RAIM portrayed in FIG. 3 may be implemented, according to some embodiments.

FIG. 7 is an illustration of experimental results of implementing hybrid RAIM in the manner illustrated in FIG. 6.

FIG. 8 is a flow diagram of a method of GNSS measurement handling for precise positioning of a GNSS device, according to an embodiment.

FIG. 9 is a block diagram of a GNSS device, according to an embodiment.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3, etc., or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used, and various modifications may be made without departing from the scope of the disclosure.

As used herein, the terms “position” and “location” are used interchangeably. Further, terms such as “position estimate,” “position determination,” “position fix,” “location estimate,” “estimated location,” “location fix,” and the like are also used interchangeably herein with regard to Global Navigation Satellite Systems (GNSS)-based positioning to refer to an estimated position of a mobile device or other device comprising a GNSS receiver. The position or location may be a two-dimensional position, e.g., with regard to a two-dimensional map, or a three-dimensional position.

As used herein, a “positioning engine” refers to one or more components (e.g., software components or modules) that perform positioning techniques to determine a position estimate of a mobile device. In a typical embodiment, a positioning engine for a mobile device is executed by one or more processors of the mobile device. A positioning engine that provides high-precision positioning (also referred to herein as a “Precise Positioning Engine (PPE)”) generally operates by obtaining pseudorange and carrier phase GNSS data from radio frequency (RF) signals from one or more GNSS constellations and further applying correction data obtained from a correction data source to apply various corrections to the GNSS data to further determine a precise position. More particularly, positioning by a PPE uses carrier-phase-based ranging by determining the number of carrier frequency cycles between a satellite and mobile device (e.g., carrier phase measurements, including changes in phase and the number of cycles of the carrier signals). Positioning performed by a PPE may be referred to herein as “precise positioning.”

A positioning engine may use, for example, a Bayesian estimator to determine one or more high-precision positions of a mobile device. Examples of Bayesian estimators that may be used include a Kalman Filter, an Extended Kalman Filter, an Unscented Kalman Filter, a particle filter, or the like. It should be noted that, as used herein, “Kalman Filter” is intended to refer to various types of Kalman Filters, such as an Extended Kalman Filter, an Unscented Kalman Filter, or the like. In some embodiments, an estimator may be used to iteratively determine states that correspond to a predicted device location over a series of time steps. Continuing with this example, the Bayesian estimator may be iteratively updated (e.g., states of the estimator may be iteratively updated) to identify a solution. The solution of the estimator may correspond to a high-precision GNSS-based position estimate of a mobile device at a time point at which the estimator has converged.

As previously noted, a GNSS receiver (e.g., at a vehicle, mobile device, etc.) may be capable of determining a high-precision position estimate using a high-precision positioning technique such as RTK or PPP. These high-precision position techniques involve the GNSS receiver receiving correction data from an RTK or PPP service and using a precise positioning engine (PPE) to apply the correction data to GNSS measurements by the GNSS receiver to obtain a position accuracy far greater than traditional (pseudorange-based) GNSS position. However, the precision of such positioning solutions can be negatively affected by GNSS measurements subject to multipath and/or other challenging conditions that can degrade GNSS measurement quality.

Various aspects of the embodiments described herein relate generally to poor-quality GNSS measurement filtering and/or de-weighting in high-precision positioning of a GNSS device. Some aspects specifically provide techniques for performing a measurement pre-check by comparing the standard deviation of pre-fit residuals of different measurement types (pseudorange (PR), carrier phase (CP), and Doppler (DR)) with a threshold to determine whether a conditional trigger has been met. In some examples, if a conditional trigger has been met for one or more measurement types, measurements of the one or more measurement types may be excluded from a measurement update by the positioning engine of the GNSS device. In some examples, if a conditional trigger has been met for one or more measurement types, a scale factor (SF) can be used to adapt the threshold to use for determining whether to skip/omit a particular measurement of one or more measurement types from the positioning solution. In some examples, if a conditional trigger has been met for one or more measurement types, a de-weighting factor (DWF) can be used to de-weight certain measurements of the one or more measurement types. In such embodiments, the DWF may be used to increase the uncertainty of the one or more measurement types.

Particular aspects of the subject matter described in this disclosure can be implemented to realize one or more of the following potential advantages. In some examples, by using a measurement pre-check to modify how/which measurements are processed by the positioning engine to determine a position estimate of the GNSS device, the described techniques can be used to increase the accuracy of the position estimate. A person of ordinary skill in the art will appreciate these and other advantages in view of the embodiments provided below. Detailed embodiments are provided after a brief discussion of relevant technology.

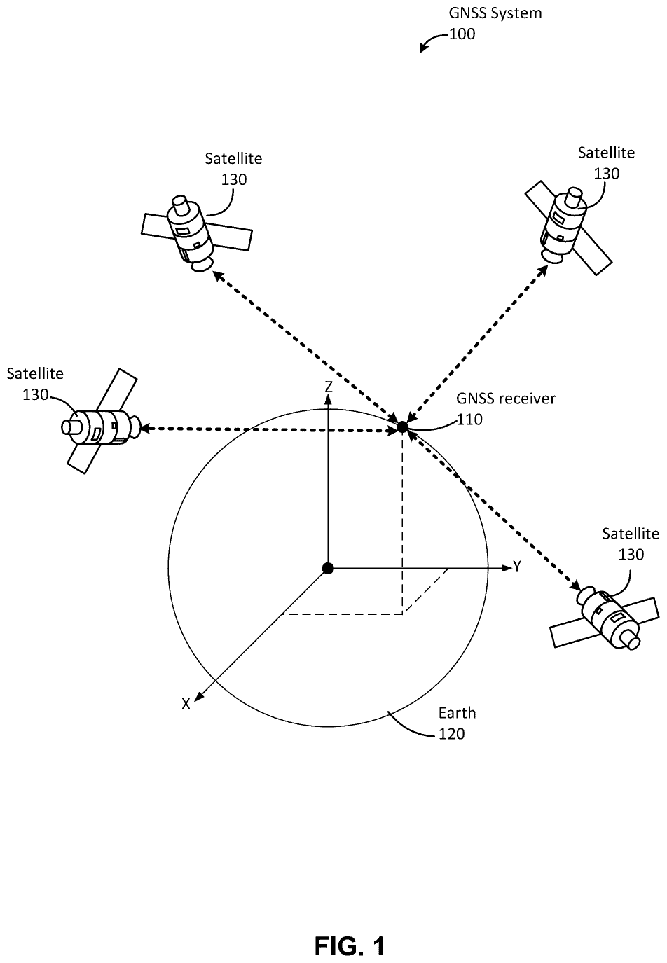

FIG. 1 is a simplified diagram of a GNSS system 100, provided to illustrate how GNSS is generally used to determine an accurate location of a GNSS receiver 110 on Earth 120 (also known as “positioning” of the GNSS receiver). Put generally, the GNSS system 100 enables an accurate GNSS position fix of the GNSS receiver 110, which receives radio frequency (RF) signals from GNSS satellites 130 from one or more GNSS constellations. (A satellite such as GNSS satellites 130 may also be referred to herein as a space vehicle (SV).) The types of GNSS receiver 110 used may vary, depending on the application. In some embodiments, for instance, the GNSS receiver 110 may comprise consumer electronics or devices, such as a mobile phone, tablet, laptop, wearable device, vehicle (or in-vehicle device), or the like. In some embodiments, the GNSS receiver 110 may comprise industrial or commercial equipment, such as survey equipment.

It will be understood that the diagram provided in FIG. 1 is greatly simplified. In practice, there may be dozens of satellites 130 and a given GNSS constellation, and there are many different types of GNSS systems. GNSS systems include, for example, Global Positioning System (GPS), Galileo (GAL), GLONASS, Quasi-Zenith Satellite System (QZSS) over Japan, Indian Regional Navigational Satellite System (IRNSS) over India, BeiDou Navigation Satellite System (BDS), and/or the like. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on multilateration, which is a method of determining position by measuring distances to points at known coordinates. In general, the determination of the position of a GNSS receiver 110 in three dimensions may rely on a determination of the distance between the GNSS receiver 110 and four or more satellites 130. As illustrated, 3D coordinates may be based on a coordinate system (e.g., XYZ coordinates; latitude, longitude, and altitude; etc.) centered at the earth's center of mass. A distance between each satellite 130 and the GNSS receiver 110 may be determined using precise measurements made by the GNSS receiver 110 of a difference in time from when a radio frequency RF signal is transmitted from the respective satellite 130 and when it is received at the GNSS receiver 110. To help ensure accuracy, not only does the GNSS receiver 110 need to make an accurate determination of when the respective signal from each satellite 130 is received, but many additional factors need to be considered and accounted for. These factors include, for example, clock differences at the GNSS receiver 110 and satellite 130 (e.g., clock bias), a precise location of each satellite 130 at the time of transmission (e.g., as determined by the broadcast ephemeris), the impact of atmospheric distortion (e.g., ionospheric and tropospheric delays), and the like.

To perform a traditional GNSS position fix, the GNSS receiver 110 can use code-based positioning to determine its distance to each satellite 130 based on a determined delay in a generated pseudorandom binary sequence received in the RF signals received from each satellite, in consideration of the additional factors and error sources previously noted. These measurements are known as pseudorange (PR) measurements. With the distance and location information of the satellites 130, the GNSS receiver 110 can then determine a position fix for its location. This position fix may be determined, for example, by a Standalone Positioning Engine (SPE) executed by one or more processors of the GNSS receiver 110. However, code-based positioning is relatively inaccurate and, without error correction, is subject to many of the previously described errors. Even so, code-based GNSS positioning can provide a positioning accuracy for the GNSS receiver 110 on the order of meters.

More accurate carrier-based ranging is based on a carrier wave of the RF signals from satellites and may use measurements at a base or reference station (not shown) to perform error correction to help reduce errors from the previously noted error sources. More specifically, errors (e.g., atmospheric errors sources) in the carrier-based ranging of satellites 130 observed by the GNSS receiver 110 can be mitigated or canceled based on similar carrier-based ranging of the satellites 130 using a highly accurate GNSS receiver at the base station at a known location. Carrier-based ranging involves the use of carrier phase (CP) measurements, although it may additionally use PR measurements. These measurements and the base station's location can be provided to the GNSS receiver 110 for error correction. This position fix may be determined, for example, by a Precise Positioning Engine (PPE) executed by one or more processors of the GNSS receiver 110. More specifically, in addition to the information provided to an SPE, the PPE may use base station GNSS measurement information and additional correction information, such as precise orbit and clock, troposphere and ionosphere, to provide a high accuracy, carrier-based position fix. Several GNSS techniques can be adopted in PPE, such as Differential GNSS (DGNSS), Real Time Kinematic (RTK), and PPP, and may provide a sub-meter accuracy (e.g., on the order of centimeters).

The high accuracy of carrier-based ranging using RTK and/or PPP error correction data can be compromised in challenging environments. More specifically, in environments such as canyons (including “urban” canyons), overpasses, or the like, the signals with which GNSS measurements are made by a GNSS receiver may be subject to multipath, which cannot be removed by base station correction. This “contamination” of GNSS measurements may result in a cycle slip for the conditions in which the positioning solution is significantly degraded if these GNSS measurements are not identified and filtered properly. Traditional techniques for identifying and filtering such erroneous GNSS measurements may involve the use of additional sensors (e.g., IMU, camera, etc.), but this can significantly increase the cost and complexity of the GNSS receiver. Other solutions may comprise Receiver Autonomous Integrity Monitoring (RAIM) to remove “bad” (e.g., large residual) measurements and maintain the accuracy and integrity of positioning solutions using filtered measurements. However, existing RAIM solutions can be improved.

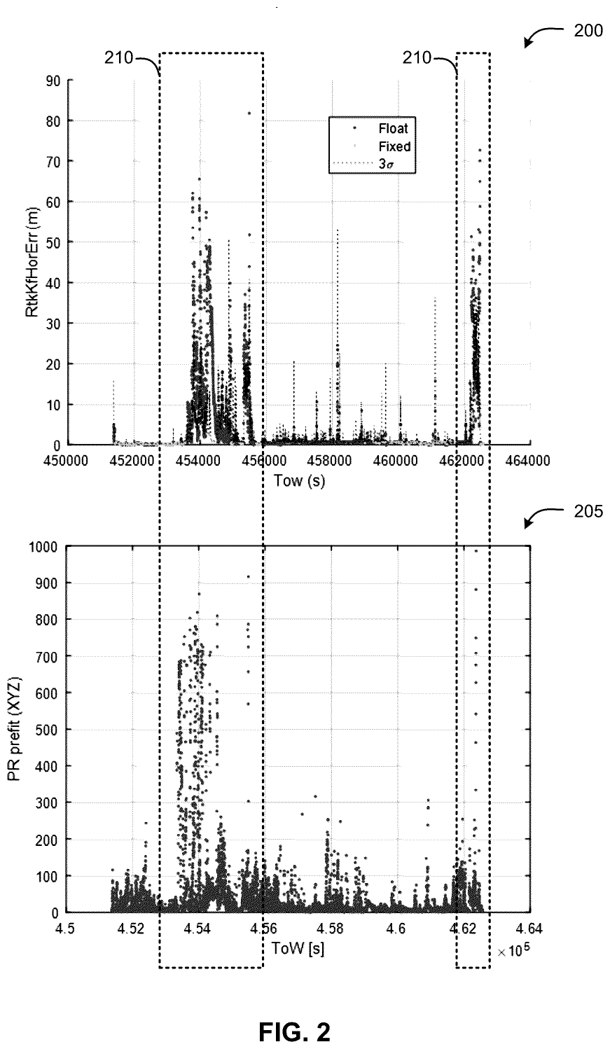

FIG. 2 is an illustration of related graphs 200 and 205 provided to show the correlation between “pre-fit” residuals of pseudorange (PR) and horizontal error (HE) of an RTK solution, using example data. As used herein, pre-fit residuals may be a measure of how newly obtained GNSS measurements may impact a positioning solution, which may be determined prior to application of the GNSS measurements in a measurement update (e.g., in a Kalman filter (KF)). The upper graph 200 illustrates the horizontal error of the RTK solution over a period of time, and the lower graph 205 illustrates the PR pre-fit measurement residuals. As can be from the graphs 200 and 205, periods of time during which PR pre-fit measurement residuals are high also result in large HE values of the RTK position solution. The also correspond with float values, rather than fixed values, for the RTK position solution. These periods of time are identified in FIG. 2 with boxes 210.

Traditional pre-fit RAIM algorithms may determine outlier GNSS measurements to filter based only on the offset of pre-fit measurement residual against the median value of pre-fit measurement residuals. However, in challenging GNSS environments, such traditional algorithms often fail to remove enough high residual measurements. Therefore, some erroneous measurements are used (rather than filtered out), resulting in position solutions having lower accuracy and a lower RTK fixing rate. The data in graphs 200 and 205 in FIG. 2, for example, represents data subject to a traditional pre-fit RAIM algorithm. Even so, the RTK positioning solution still resulted in a low RTK fixing rate and high HE during the period of time in boxes 210.

Embodiments herein address these and other issues by implementing an adaptive and/or hybrid RAIM to help identify additional erroneous measurements. These identified measurements may then be properly rejected (or de-weighted), which can improve the accuracy of an RTK and/or PPP positioning solution.

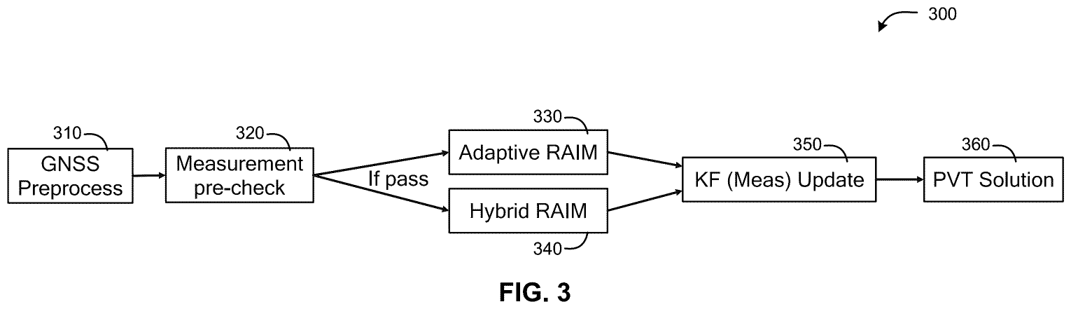

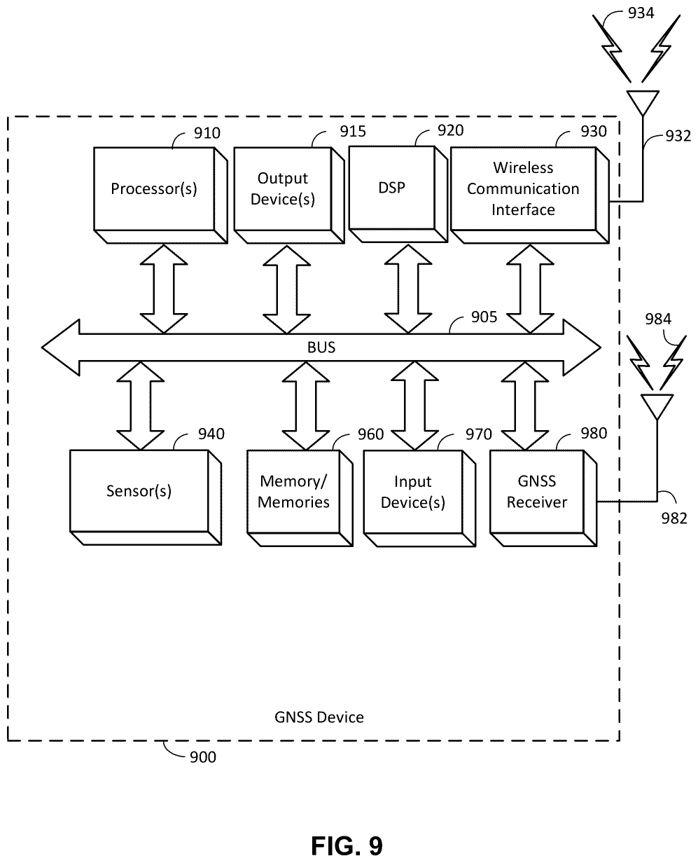

FIG. 3 is a block diagram of a method 300 of handling GNSS measurements for RTK and/or PPP positioning using adaptive and/or hybrid RAIM, according to an embodiment. Some or all of the operations of the method 300 may be performed by a positioning engine of a GNSS device. As noted hereafter, such a positioning engine may be implemented in a GNSS receiver, modem, application processor, and/or other hardware and/or software components of a GNSS device. Example components of a GNSS device are described hereafter in relation to FIG. 9.

The method 300 may begin at block 310, in which GNSS measurements are preprocessed, in preparation for the measurement pre-check performed at block 320. In the measurement pre-check of block 320, the standard deviation of measurements of a particular type (e.g., pseudorange (PR), carrier phase (CP), Doppler (DR), or any combination thereof), may be calculated to determine whether a conditional trigger and/or has been met. If so, the process may proceed to the functionality at block 330 or block 340, in which an adaptive RAIM and/or hybrid RAIM is/are performed. Different embodiments, environmental factors, and/or other factors may be taken into consideration when determining whether to use adaptive RAIM or hybrid RAIM. If no conditional trigger is met, traditional RAIM may be used. As described in more detail hereafter, the adaptive RAIM may use an additional scale factor (SF) to exclude selected measurements of one or more measurement types in a pre-fit RAIM module based on the conditional trigger that was met. The adaptive RAIM may serve to provide a relatively aggressive RAIM logic. As also described in more detail hereafter, the hybrid RAIM may de-weight selected measurements of one or more measurement types in the pre-fit RAIM module based on the conditional trigger that was met. The hybrid RAIM may serve to provide a relatively less aggressive RAIM logic (e.g., compared with the adaptive RAIM). The method 300 may then proceed to the functionality illustrated at block 350, in which the GNSS measurements (e.g., as modified/filtered using adaptive RAIM or hybrid RAIM) are used to perform a Kalman filter (KF) measurement update. The update may then be used to provide a positioning solution (e.g., indicating Position, Velocity, and Time (PVT)) for the GNSS receiver, as indicated at block 360. Among other things, this positioning solution may be based on the GNSS measurements used in the Kalman filter (KF) measurement update and RTK/PPP corrections.

With respect to the measurement pre-check at block 320, different conditional triggers may be used for implementing adaptive RAIM and/or hybrid RAIM. According to some embodiments, these conditional triggers may comprise whether:
(1) the standard deviation of PR pre-fit residuals is greater than a threshold for PR pre-fit residuals,
(2) the standard deviation of the CP pre-fit residuals is greater than a threshold for CP pre-fit residuals, or
(3) the standard deviation of the DR pre-fit residuals is greater than a threshold for DR pre-fit residuals.

With respect to each measurement type, the respective threshold may be predetermined using a regression analysis, for example, in which a threshold is chosen and performed on a variety of data sets. It can be noted that a threshold used in the measurement pre-check at block 320 (and/or at threshold used in adaptive and/or hybrid RAIM at blocks 330 and 340) but may only be specific to a particular measurement type (PR, CP, DR), but additionally or alternatively other factors, such as positioning methodology (e.g., RTK, PPP, etc.), environmental factors, uncertainty, timing, etc., or any combination thereof, and may be predetermined or dynamically-determined (e.g., based on current factors). As noted in FIG. 3 and described in further detail hereafter, if one or more conditional triggers are met, adaptive RAIM and/or hybrid RAIM may be used to remove and/or de-weight certain measurements prior to performing the KF measurement update at block 350.

It can be noted, however, that some embodiments may simply omit updating all measurements of a measurement type in the positioning engine if certain conditional triggers are met. As previously noted, GNSS measurements may include PR, CP, and DR measurements, all of which may be used in a KF measurement update (block 350) in the positioning engine. In various situations, refraining from performing a measurement update for a measurement type (PR, CP, DR) can decrease the horizontal error (HE) of a positioning solution in cases where the standard deviation of measurements for the measurement type exceeds the corresponding threshold for that measurement type. For example, in cases where conditional trigger (1) is met, refraining from performing a PR measurement update in the positioning engine can result in increased accuracy (reduced HE). Likewise for other measurement types. That said, skipping measurement updates in this manner can lead to a positioning engine (KF) running in a pure time update mode (e.g., when conditional triggers for all measurement types are met). If the dynamic model is not accurate, the positioning solution will drift away as long as the conditional trigger is on.

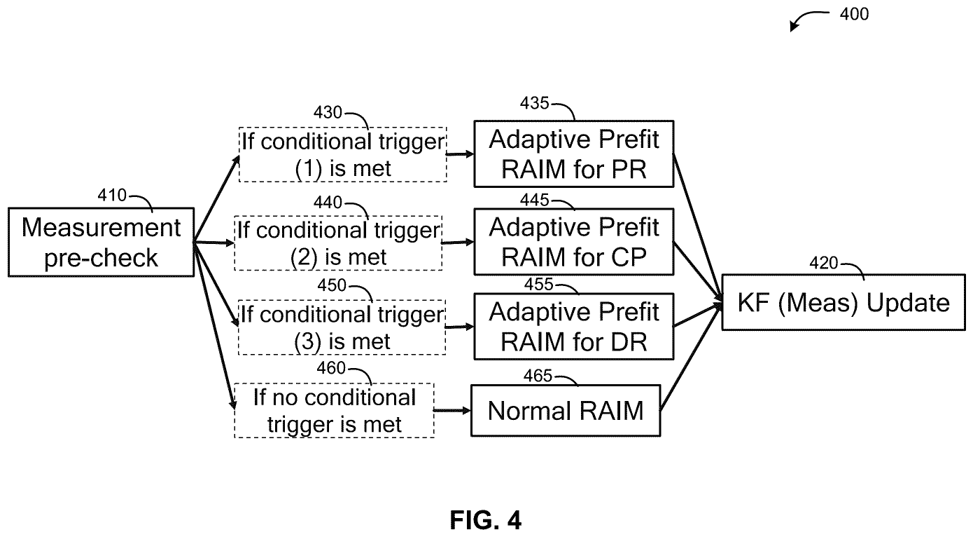

With this in mind, adaptive and/or hybrid RAIM may be implemented when one or more of the conditional triggers are met. An example of this is illustrated in FIG. 4.

FIG. 4 is a block diagram 400 of how certain operations related to adaptive RAIM portrayed in FIG. 3 may be implemented, according to some embodiments. Here, the measurement pre-check at block 410 may correspond with the measurement pre-check at block 320 of FIG. 3, and the KF measurement update at block 420 may correspond with the KF measurement update at block 350 of FIG. 3. FIG. 4 provides additional detail regarding how adaptive RAIM may be performed, based on which conditional trigger(s) is/are met.

As shown in FIG. 4, when different conditional triggers (triggers (1)-(3) described above) are met, different adaptive RAIM may be implemented on the respective measurement type of the conditional trigger. That is, if conditional trigger (1) (corresponding with PR measurements) is met, as indicated at block 430, an adaptive prefit RAIM for PR pre-fit residuals may be performed, as indicated at block 435. Similarly, if conditional trigger (2) (corresponding with CP measurements) is met, as indicated at block 440, an adaptive pre-fit RAIM for CP pre-fit residuals may be performed, as indicated at block 445. Finally, if conditional trigger (3) (corresponding with DR measurements) is met, as indicated at block 450, an adaptive pre-fit RAIM for DR pre-fit residuals may be performed, as indicated at block 455. Otherwise, if no conditional trigger is met, as indicated at block 460, a “normal” (e.g., traditional) RAIM may be performed, as indicated at block 465.

As previously noted, the functionality of the adaptive pre-fit RAIM for the various measurement types, as indicated at block 435, 445, and 455 of FIG. 4), can involve the use of a scale factor (SF). For example, while the normal RAIM at block 465 may use a standard RAIM threshold for filtering PR pre-fit residuals, adaptive pre-fit RAIM for PR at block 435 may multiply the standard RAIM threshold by a SF. If PR pre-fit residuals exceed that scaled threshold, the adaptive pre-fit RAIM for PR, at block 435, may then omit the PR pre-fit residuals from the KF measurement update at block 420. Similar processes would be implemented for pre-fit residuals of other measurement types (CP and DR).

Depending on desired functionality, the SF and/or standard RAIM threshold for each measurement type may be unique to that type or may be common among two or all three measurement types. Additionally or alternatively, the SF and/or standard RAIM threshold may vary based on one or more additional factors, such as positioning methodology (e.g., RTK, PPP, etc.), environmental factors, uncertainty, timing, etc., or any combination thereof, and may be predetermined or dynamically-determined (e.g., based on current factors). The standard RAIM threshold for a given measurement type may be a function of measurement noise matrix (R), observation matrix (H), and KF state covariance. Further, according to some embodiments, the SF value may be heavily tuned based on the regression of multiple data libraries. A default value for SF may be 0.1, for example. (An SF of less than 1 would lead to filtering more pre-fit residuals than normal RAIM.) Other embodiments may have a higher or lower SF. And the SF may be tuned over time, depending on a particular device and/or application.

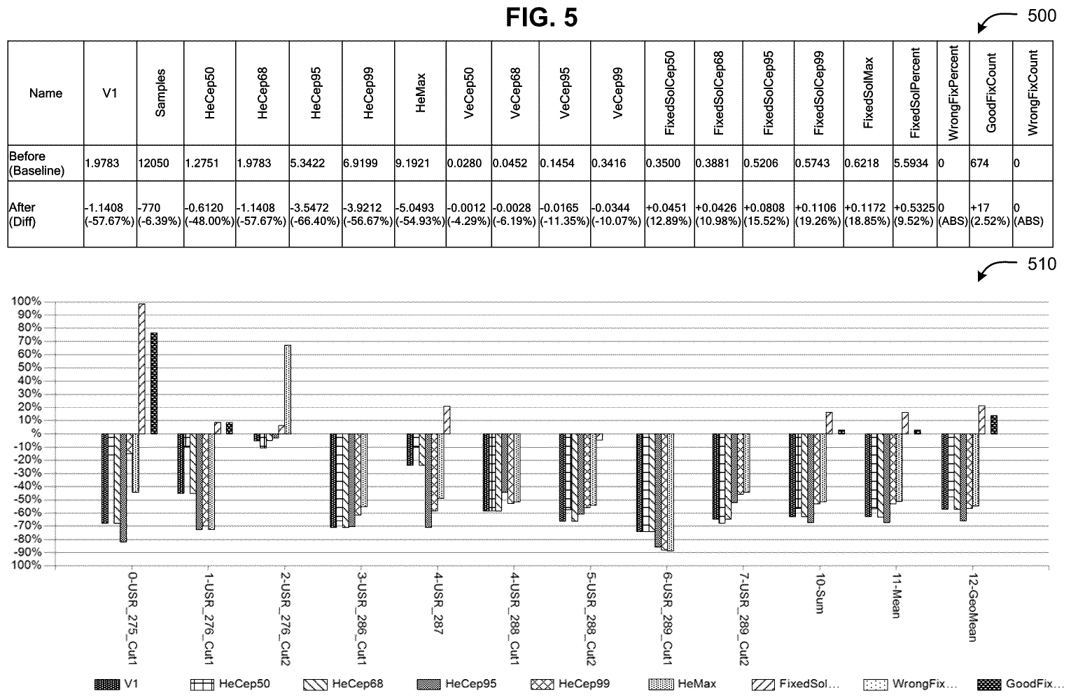

FIG. 5 is an illustration of some experimental results of implementing adaptive RAIM in the manner illustrated in FIG. 4, described above. Here, the experimental results are based on data from a library of mobile logs in challenging environments.

Table 500 shows statistics for horizontal error (columns beginning with the letters “He”), horizontal velocity (beginning with “Ve”), and other information of positioning value samples. Horizontal error and horizontal velocity are further split into percentages (50%, 68%, 95%, and 99%), indicating a respective percentage of samples having error values at or below the indicated error value. Rows are split into “before” implementing adaptive RAIM (e.g., implementing normal/traditional RAIM), and “after” implementing adaptive RAIM. (The row having values implementing adaptive RAIM further includes a differential, in parentheses, showing the “after” value as a percentage of the “before” value.) As can be seen, the horizontal error is reduced in the “after” implementation at all percentage values. For example, where 50% of the “before” values have a horizontal error of 1.2751 m (col. “HeCep 50”), 50% of the “after” values have a horizontal error of 0.6120 m, which is just 48% of the “before” value. Further, the percentage of “fixed” samples increases after adaptive RAIM is applied.

Graph 510 provides a further illustration of the experimental results. In graph 510, results for various data sets corresponding to the mobile logs are plotted and grouped by data set. Each data set begins with a number (e.g., 0, 1, 2, etc.), And the final three data sets (10, 11, and 12) are statistical combinations of the previous data sets (sum, mean, and geomean). Each group includes a bar graph in which some of the data corresponding to the columns of table 500 is plotted, showing an increase or decrease as a percentage of “before”/baseline values. Of particular interest is horizontal error (again, beginning with “He”), which decreases in nearly every instance.

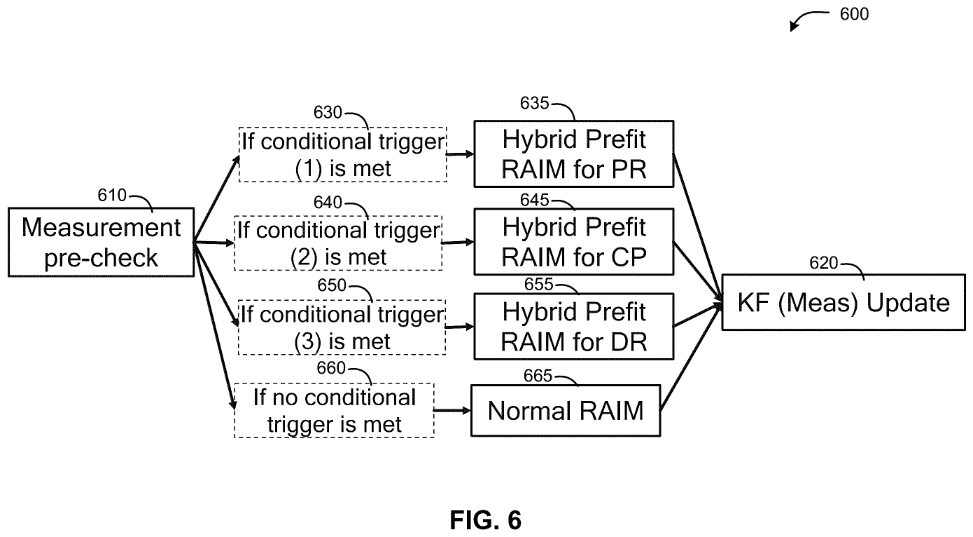

FIG. 6 is a block diagram 600 of how certain operations related to hybrid RAIM portrayed in FIG. 3 may be implemented, according to some embodiments. Here, the measurement pre-check at block 610 may correspond with the measurement pre-check at block 320 of FIG. 3, and the KF measurement update at block 620 may correspond with the KF measurement update at block 350 of FIG. 3. FIG. 6 provides additional detail regarding how adaptive RAIM may be performed, based on which conditional trigger(s) is/are met.

Similar to FIG. 4, FIG. 6 illustrates that when different conditional triggers (triggers (1)-(3) described above) are met, different hybrid RAIM may be implemented on the respective measurement type of the conditional trigger. That is, if conditional trigger (1) (corresponding with PR measurements) is met, as indicated at block 630, a hybrid pre-fit RAIM for PR pre-fit residuals may be performed, as indicated at block 635. Similarly, if conditional trigger (2) (corresponding with CP measurements) is met, as indicated at block 640, a hybrid pre-fit RAIM for CP pre-fit residuals may be performed, as indicated at block 645. Finally, if conditional trigger (3) (corresponding with DR measurements) is met, as indicated at block 650, a hybrid pre-fit RAIM for DR pre-fit residuals may be performed, as indicated at block 655. Otherwise, if no conditional trigger is met, as indicated at block 660, a “normal” (e.g., traditional) RAIM may be performed, as indicated at block 665.

As noted above, hybrid RAIM (which may include the hybrid pre-fit RAIM for the various measurement types, as indicated at block 635, 645, and 655 of FIG. 6) can involve de-weighting measurements of a given measurement type when performing the KF measurement update (e.g., at block 620). Further, the hybrid RAIM may be used in conjunction with a scale factor of the type previously described with respect to the adaptive RAIM of FIG. 4. For example, normal RAIM filtering of PR measurements may be performed at block 665 if a pre-fit residual is larger than a standard threshold. However, for pre-fit residuals that are less than the standard threshold but greater than the standard threshold multiplied by an SF, the hybrid pre-fit RAIM for PR at block 635 may apply a de-weight factor (DWF) to corresponding PR measurements in the KF measurement update. According to some embodiments, although a conditional trigger (e.g., performed at blocks 630, 640, and/or 650) may be based on all measurements of a particular measurement type (PR, CP, DR), the functionality of the hybrid pre-fit RAIM blocks 635, 645, and 655) may apply the DWF to particular measurements (e.g., which may be identified as having a pre-fit residual greater than the scaled threshold). Again, similar processes may be implemented for other measurement types (CP and DR). Depending on desired functionality, the SF and/or DWF for each measurement type may be unique to that measurement type or may be common among two or all three measurement types, and may vary based on factors such as positioning methodology (e.g., RTK, PPP, etc.), environmental factors, uncertainty, timing, etc., or any combination thereof, and may be predetermined or dynamically-determined (e.g., based on current factors). Further, similar to the SF, the DWF value may be heavily tuned based on regression of multiple data libraries. According to some embodiments, the DWF may de-weight a measurement by scaling up the uncertainty of the measurement. (Higher uncertainty can reduce the impact of the measurement in the KF measurement update.) A DWF in this case may be 10, for example. Other embodiments may have a higher or lower DWF. And the SF may be tuned over time, depending on a particular device and/or application.

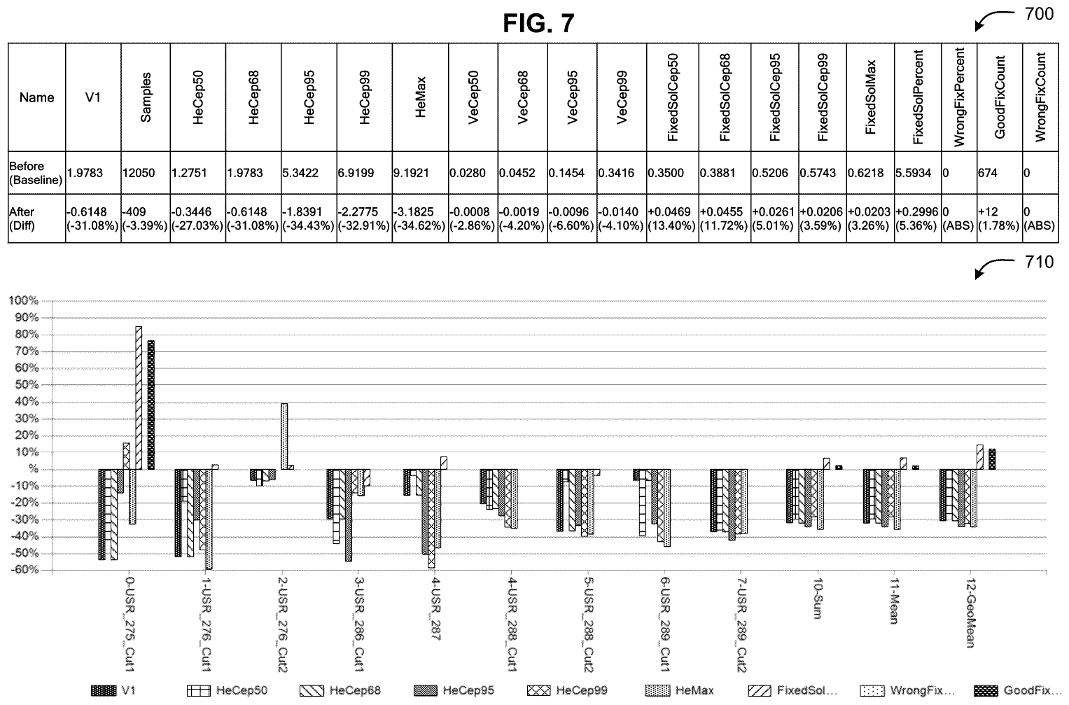

FIG. 7 is an illustration of experimental results of implementing hybrid RAIM in the manner illustrated in FIG. 6, described above. The experimental results are based on the same data as used for FIG. 5.

Table 700 shows values similar to the table 500 of FIG. 5. Because table 700 deals with the same data set as the data used in table 500, the values in the “before” row (values prior to implementing the hybrid RAIM) are the same. However, values in the “after” row are different than those in the corresponding row of table 500. That said, similar to the “after” row in table 500, the “after” row in table 700 show reductions in horizontal error and velocity estimations compared with the “before” row. These reductions can be significant. For example, where 50% of the “before” values have a horizontal error of 1.2751 m (col. “HeCep 50”), 50% of the “after” values have a horizontal error of 0.3446 m, which is just 27% of the “before” value.

Graph 710 (similar to graph 510) provides a further illustration of the experimental results in which results for various data sets corresponding to the mobile logs are plotted and grouped by data set. Each group includes a bar graph in which some of the data corresponding to the columns of table 700 is plotted. Similar to graph 510 in which the data show adaptive RAIM decreases nearly every horizontal error metric, graph 710 also shows a decrease nearly every horizontal error metric with the use of hybrid RAIM.

The use of adaptive RAIM or hybrid RAIM-or more generally, the use of a scaling factor (SF) and/or a de-weighting factor (DWF)-may vary, depending on desired functionality. As described in the above embodiments, adaptive RAIM uses an SF to filter measurements entirely from being used in the KF measurement update. On the other hand, hybrid RAIM uses a DWF (which may be used in conjunction with an SF) to de-weight measurements from the KF measurement update. Thus, as previously noted, adaptive RAIM may be considered more aggressive than hybrid RAIM because it removes rather than de-weights certain measurements. With this in mind, adaptive RAIM or hybrid RAIM may be utilized in different embodiments, different applications, and/or in different challenging environments, depending on desired functionality. It may be determined, for example, that one approach is preferable over another in certain applications and/or environments. This may be based on data collected and analyzed in such environments. Moreover, in some embodiments, hybrid and/or adaptive RAIM as described herein may be implemented to handle RTK and/or PPP measurements based on additional or alternative triggers (e.g., other than the measurement pre-check as described herein). Factors that may be considered when determining whether to use adaptive RAIM and/or hybrid RAIM may include an environment (e.g.,. in which the GNSS receiver is located) and/or measurement uncertainty.

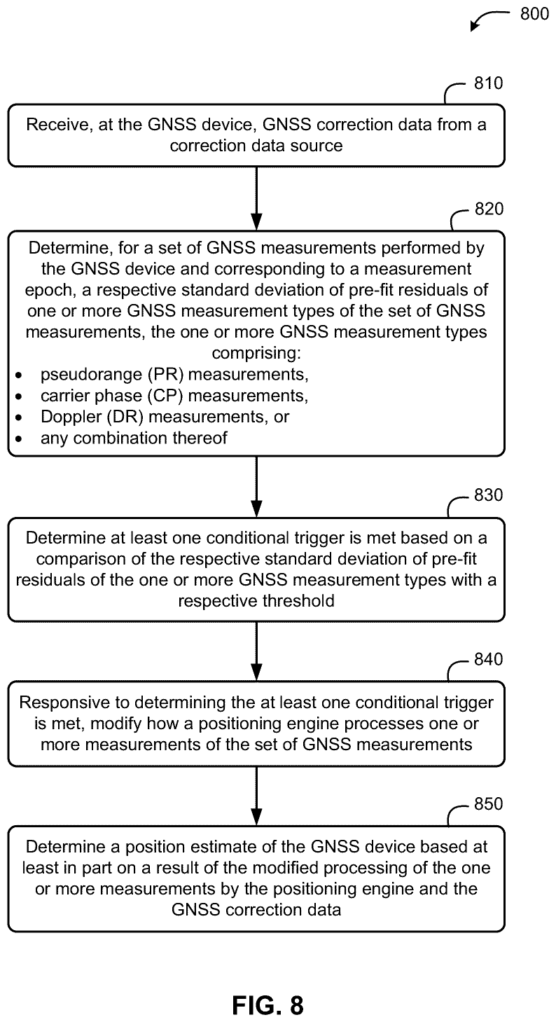

FIG. 8 is a flow diagram of a method 800 of global navigation satellite system (GNSS) measurement handling for precise positioning of a GNSS device, according to an embodiment. Means/structure for performing the functionality illustrated in one or more of the blocks shown in FIG. 8 may be performed by hardware and/or software components of a GNSS device. In particular, means and/structure may include a GNSS receiver and/or one or more processors (e.g., an application processor), including one or more software applications/modules/functions executed thereby. Example components of a GNSS receiver are illustrated in FIG. 9, which is described in more detail below.

At block 810, the functionality comprises receiving, at the GNSS device, GNSS correction data from a correction data source. As described in the embodiments above, a correction data may comprise RTK and/or PPP correction data, which may be provided to the GNSS device via a communication link (e.g., wireless connection) by a correction data source (e.g., RTK/PPP correction service). The way in which a GNSS device may receive such correction data may vary, depending on implementation. According to some embodiments, correction data may be received on a per-request basis, based on a predetermined schedule, periodically (e.g., based on the previous request), or the like

Means for performing functionality at block 810 may comprise a bus 905, one or more processors 910, DSP 920, memory/memories 960, GNSS receiver 980, and/or other components of a GNSS device 900, as illustrated in FIG. 9.

At block 820, the functionality comprises determining, for a set of GNSS measurements performed by the GNSS device and corresponding to a measurement epoch, a respective standard deviation of pre-fit residuals of one or more GNSS measurement types of the set of GNSS measurements, the one or more GNSS measurement types comprising: pseudorange (PR) measurements, carrier phase (CP) measurements, Doppler (DR) measurements, or any combination thereof. This functionality may correspond with at least some aspects of the measurement pre-check as described in the embodiments above (e.g., at block 320 of FIG. 3, 410 of FIGS. 4, and 610 of FIG. 6), for example.

Means for performing functionality at block 820 may comprise a bus 905, one or more processors 910, DSP 920, memory/memories 960, GNSS receiver 980, and/or other components of a GNSS device 900, as illustrated in FIG. 9.

At block 830, the functionality comprises determining at least one conditional trigger is met based on a comparison of the respective standard deviation of pre-fit residuals of the one or more GNSS measurement types with a respective threshold. This functionality (e.g., in addition to the functionality at block 820), may correspond with at least some aspects of the measurement pre-check as described in the embodiments above (e.g., at block 320 of FIG. 3, 410 of FIGS. 4, and 610 of FIG. 6), for example. As previously noted, different measurement types may have the same or different respective thresholds, which may be based on various factors. According to some embodiments, the respective threshold may be based at least in part on the one or more GNSS measurement types, whether the GNSS correction data comprises RTK correction data or PPP correction data, an environment, a measurement uncertainty, or any combination thereof. According to some embodiments, the environment may comprise an environment or environment type (e.g., indoors, outdoors, in a canyon, in an urban area, etc.) in which the GNSS device is located.

Means for performing functionality at block 830 may comprise a bus 905, one or more processors 910, DSP 920, memory/memories 960, GNSS receiver 980, and/or other components of a GNSS device 900, as illustrated in FIG. 9.

At block 840, the functionality comprises, responsive to determining the at least one conditional trigger is met, modifying how a positioning engine processes one or more measurements of the set of GNSS measurements. As noted in the embodiments described above, these modifications may comprise refraining from including measurements of a measurement type in a measurement update, applying adaptive RAIM, applying hybrid RAIM, or any combination thereof. More specifically, according to some embodiments, modifying how the positioning engine processes one or more measurements of the set of GNSS measurements may comprise using only a subset of the set of GNSS measurements for a measurement update performed by the positioning engine, wherein the subset of the set of GNSS measurements excludes all measurements of at least one measurement type of the one or more GNSS measurement types. Here, a positioning engine may comprise an RTK/PPP engine, or (more generally) a PPE. Additionally or alternatively, modifying how the positioning engine processes one or more measurements of the set of GNSS measurements may comprise (i) using a scale factor (SF) to modify a processing threshold, (ii) for each measurement of the one or more measurements, comparing a respective pre-fit residual of the measurement with the modified processing threshold, and (iii) responsive to the comparison of the respective pre-fit residual of the measurement with the modified processing threshold, excluding at least one of the one or more measurements from a measurement update performed by the positioning engine. At least some aspects of this functionality may correspond with adaptive RAIM as described herein (e.g., with respect to FIGS. 4 and 5). Additionally or alternatively, modifying how the positioning engine processes one or more measurements of the set of GNSS measurements may comprise (i) for each measurement of the one or more measurements, comparing a respective pre-fit residual of the measurement with a weighting threshold, and (ii) responsive to the comparison of the respective pre-fit residual of the measurement with the weighting threshold, changing a respective weight of at least one of the one or more measurements used in a measurement update performed by the positioning engine. At least some aspects of this functionality may correspond with hybrid RAIM as described herein (e.g., with respect to FIGS. 6 and 7). As noted herein, in such embodiments, the weighting threshold may comprise a processing threshold modified by a scale factor (SF). Additionally or alternatively, in such embodiments, changing the respective weight of the at least one of the one or more measurements it comprise increasing a respective uncertainty corresponding to the at least one of the one or more measurements. As explained herein, this may be done using a de-weighting factor (DWF).

Means for performing functionality at block 840 may comprise a bus 905, one or more processors 910, DSP 920, memory/memories 960, GNSS receiver 980, and/or other components of a GNSS device 900, as illustrated in FIG. 9.

At block 850, the functionality comprises determining a position estimate of the GNSS device based at least in part on a result of the modified processing of the one or more measurements by the positioning engine and the GNSS correction data. This determination may be performed, for example, in accordance with traditional RTK/PPP positioning, but using the modified processing of one or more measurements described in the previous operations of the method 800, rather than traditional means (e.g., traditional RAIM). The position estimate may be output to a device or system, depending on desired functionality. According to some embodiments, for example, an indication of the position estimate may be provided to a processor, application, and/or operating system of the GNSS device. Additionally or alternatively, an indication of the position estimate may be provided to another device (communicatively coupled with the GNSS device) or system, to a user of the GNSS device (e.g., via a user interface such as a display), or the like.

Means for performing functionality at block 850 may comprise a bus 905, one or more processors 910, DSP 920, memory/memories 960, GNSS receiver 980, and/or other components of a GNSS device 900, as illustrated in FIG. 9.

FIG. 9 is a block diagram of various hardware and software components of a GNSS device 900, according to an embodiment. These components can be utilized as described herein above (e.g. in association with FIGS. 1-8). For example, the GNSS device 900 can perform the operations of the methods illustrated in FIGS. 3, 4, 6, and 8, and/or one or more of the functions of a GNSS device as described in the embodiments herein. It should be noted that FIG. 9 is meant only to provide a generalized illustration of various components, any or all of which may be utilized as appropriate. As previously noted, GNSS device 900 may vary in form and function, and may ultimately comprise any GNSS-enabled device, including vehicles, commercial and consumer electronic devices, survey equipment, and more.

The GNSS device 900 is shown comprising hardware elements that can be electrically coupled via a bus 905 (or may otherwise be in communication, as appropriate). The hardware elements may include one or more processors 910 which can include without limitation one or more general-purpose processors, one or more special-purpose processors (such as DSP chips, graphics processors (GPUs), application specific integrated circuits (ASICs), and/or the like), and/or other processor, processing structure, processing unit, or processing means. As shown in FIG. 9, some embodiments may have a separate DSP 920, depending on desired functionality. Location determination and/or other determinations based on wireless communication may be provided in the processor(s) 910 and/or wireless communication interface 930 (discussed below). The GNSS device 900 also can include one or more input devices 970, which can include without limitation a keyboard, touch screen, a touch pad, microphone, button(s), dial(s), switch(es), and/or the like; and one or more output devices 915, which can include without limitation a display, light emitting diode (LED), speakers, and/or the like. As will be appreciated, the type of input devices 970 and output devices 915 may depend on the type of GNSS device 900 with which the input devices 970 and output devices 915 are integrated.

The GNSS device 900 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX™ device, a Wide Area Network (WAN) device and/or various cellular devices, etc.), and/or the like, which may enable the GNSS device 900 to communicate via networks and/or directly with other devices as described herein. The wireless communication interface 930 may permit data and signaling to be communicated (e.g. transmitted and received) with a network, for example, via WAN access points, cellular base stations and/or other access node types, and/or other network components, computer systems, and/or any other electronic devices described herein. The communication can be carried out via one or more wireless communication antenna(s) 932 that send and/or receive wireless signals 934. The antenna(s) 932 may comprise one or more discrete antennas, one or more antenna arrays, or any combination.

Depending on desired functionality, the wireless communication interface 930 may comprise separate transceivers, a separate receiver and transmitter, or any combination of transceivers, transmitters, and/or receivers to communicate with base stations and other terrestrial transceivers, such as wireless devices and access points. The GNSS device 900 may communicate with different data networks that may comprise various network types. For example, a Wireless Wide Area Network (WWAN) may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX™ (IEEE 802.16) network, and so on. A CDMA network may implement one or more radio access technologies (RATs) such as CDMA2000®, Wideband CDMA (WCDMA), and so on. CDMA2000® includes IS-95, IS-2000, and/or IS-856 standards. A TDMA network may implement Global System for Mobile Communications (GSM), Digital Advanced Mobile Phone System (D-AMPS), or some other RAT. An OFDMA network may employ Long-Term Evolution (LTE), LTE Advanced, 5G NR, 6G, and so on. 5G NR, LTE, LTE Advanced, GSM, and WCDMA are described in documents from the Third Generation Partnership Project (3GPP™). CDMA2000® is described in documents from a consortium named “3rd Generation Partnership Project 2” (3GPP2). 3GPP™ and 3GPP2 documents are publicly available. A wireless local area network (WLAN) may also be an IEEE 802.11x network, and a wireless personal area network (WPAN) may be a Bluetooth® network, an IEEE 802.15x, or some other type of network. The techniques described herein may also be used for any combination of WWAN, WLAN and/or WPAN.

The GNSS device 900 can further include sensor(s) 940. Sensors 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to complement and/or facilitate the location determination described herein, in some instances.

Embodiments of the GNSS device 900 may also include a GNSS receiver 980 capable of receiving signals 984 from one or more GNSS satellites (e.g., satellites 130) as described herein using an antenna 982 (which could be the same as antenna 932). The GNSS receiver 980 can extract a position of the GNSS device 900, using conventional techniques, from GNSS SVs of a GNSS system (e.g., satellites 130), such as GPS, GAL, Global Navigation Satellite System (GLONASS), Quasi-Zenith Satellite System (QZSS) over Japan, Indian Regional Navigational Satellite System (IRNSS) over India, Beidou Navigation Satellite System (BDS), and/or the like. Moreover, the GNSS receiver 980 can be used with various augmentation systems (e.g., Satellite-based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 illustrated in FIG. 9 is illustrated as a component distinct from other components within a GNSS device 900, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a positioning engine, such as those described herein (e.g., a an Kalman filter, WLS, particle filter, etc.), which can use GNSS measurements from the measurement engine and RTK correction information to determine a position of the GNSS receiver. The positioning engine may also be executed by one or more processors, such as processor(s) 910 and/or DSP 920.

The GNSS device 900 may further include and/or be in communication with a memory 960. The memory 960 may comprise a machine-or computer-readable medium, which can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the GNSS device 900 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the GNSS device 900 (and/or processor(s) 910 or DSP 920 within GNSS device 900). In an aspect, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method of global navigation satellite system (GNSS) measurement handling for precise positioning of a GNSS device, the method comprising: receiving, at the GNSS device, GNSS correction data from a correction data source; determining, for a set of GNSS measurements performed by the GNSS device and corresponding to a measurement epoch, a respective standard deviation of pre-fit residuals of one or more GNSS measurement types of the set of GNSS measurements, the one or more GNSS measurement types comprising: pseudorange (PR) measurements, carrier phase (CP) measurements, Doppler (DR) measurements, or any combination thereof; determining at least one conditional trigger is met based on a comparison of the respective standard deviation of pre-fit residuals of the one or more GNSS measurement types with a respective threshold; responsive to determining the at least one conditional trigger is met, modifying how a positioning engine processes one or more measurements of the set of GNSS measurements; and determining a position estimate of the GNSS device based at least in part on a result of the modified processing of the one or more measurements by the positioning engine and the GNSS correction data.

Clause 2: The method of clause 1, wherein modifying how the positioning engine processes one or more measurements of the set of GNSS measurements comprises using only a subset of the set of GNSS measurements for a measurement update performed by the positioning engine, wherein the subset of the set of GNSS measurements excludes all measurements of at least one measurement type of the one or more GNSS measurement types.

Clause 3: The method of any one of clauses 1-2 wherein modifying how the positioning engine processes one or more measurements of the set of GNSS measurements comprises: using a scale factor (SF) to modify a processing threshold; for each measurement of the one or more measurements, comparing a respective pre-fit residual of the measurement with the modified processing threshold; and responsive to the comparison of the respective pre-fit residual of the measurement with the modified processing threshold, excluding at least one of the one or more measurements from a measurement update performed by the positioning engine.

Clause 4: The method of any one of clauses 1-3 wherein modifying how the positioning engine processes one or more measurements of the set of GNSS measurements comprises: for each measurement of the one or more measurements, comparing a respective pre-fit residual of the measurement with a weighting threshold; and responsive to the comparison of the respective pre-fit residual of the measurement with the weighting threshold, changing a respective weight of at least one of the one or more measurements used in a measurement update performed by the positioning engine.

Clause 5: The method of clause 4 wherein the weighting threshold comprises a processing threshold modified by a scale factor (SF).

Clause 6: The method of any one of clauses 4-5 wherein changing the respective weight of the at least one of the one or more measurements comprises increasing a respective uncertainty corresponding to the at least one of the one or more measurements.

Clause 7: The method of any one of clauses 1-6 wherein the GNSS correction data comprises real-time kinematic (RTK) or precise point positioning (PPP) correction data.

Clause 8: The method of any one of clauses 1-7 wherein the respective threshold is based at least in part on: the one or more GNSS measurement types, whether the GNSS correction data comprises RTK correction data or PPP correction data, an environment, a measurement uncertainty, or any combination thereof.

Clause 9: A GNSS device for global navigation satellite system (GNSS) measurement handling for precise positioning of a GNSS device, the GNSS device comprising: one or more transceivers; one or more memories; and one or more processors communicatively coupled with the one or more transceivers and the one or more memories, wherein the one or more processors are configured to: receive, via the one or more transceivers, GNSS correction data from a correction data source; determine, for a set of GNSS measurements performed by the GNSS device and corresponding to a measurement epoch, a respective standard deviation of pre-fit residuals of one or more GNSS measurement types of the set of GNSS measurements, the one or more GNSS measurement types comprising: pseudorange (PR) measurements, carrier phase (CP) measurements, Doppler (DR) measurements, or any combination thereof; determine at least one conditional trigger is met based on a comparison of the respective standard deviation of pre-fit residuals of the one or more GNSS measurement types with a respective threshold; responsive to determining the at least one conditional trigger is met, modifying how a positioning engine processes one or more measurements of the set of GNSS measurements; and determine a position estimate of the GNSS device based at least in part on a result of the modified processing of the one or more measurements by the positioning engine and the GNSS correction data.

Clause 10: The GNSS device of clause 9, wherein to modify how the positioning engine processes one or more measurements of the set of GNSS measurements the one or more processors are configured to use only a subset of the set of GNSS measurements for a measurement update performed by the positioning engine, wherein the subset of the set of GNSS measurements excludes all measurements of at least one measurement type of the one or more GNSS measurement types.

Clause 11: The GNSS device of any one of clauses 9-10 wherein, to modify how the positioning engine processes one or more measurements of the set of GNSS measurements, the one or more processors are configured to use a scale factor (SF) to modify a processing threshold; for each measurement of the one or more measurements, compare a respective pre-fit residual of the measurement with the modified processing threshold; and responsive to the comparison of the respective pre-fit residual of the measurement with the modified processing threshold, exclude at least one of the one or more measurements from a measurement update performed by the positioning engine.

Clause 12: The GNSS device of any one of clauses 9-11 wherein, to modify how the positioning engine processes one or more measurements of the set of GNSS measurements, the one or more processors are configured to for each measurement of the one or more measurements, compare a respective pre-fit residual of the measurement with a weighting threshold; and responsive to the comparison of the respective pre-fit residual of the measurement with the weighting threshold, change a respective weight of at least one of the one or more measurements used in a measurement update performed by the positioning engine.

Clause 13: The GNSS device of clause 12 wherein the weighting threshold comprises a processing threshold modified by a scale factor (SF).

Clause 14: The GNSS device of any one of clauses 12-13 wherein, to change the respective weight of the at least one of the one or more measurements, the one or more processors are configured to increase a respective uncertainty corresponding to the at least one of the one or more measurements.

Clause 15: The GNSS device of any one of clauses 9-14 wherein the GNSS correction data comprises real-time kinematic (RTK) or precise point positioning (PPP) correction data.

Clause 16: The GNSS device of any one of clauses 9-15 wherein the respective threshold is based at least in part on: the one or more GNSS measurement types, whether the GNSS correction data comprises RTK correction data or PPP correction data, an environment, a measurement uncertainty, or any combination thereof.

Clause 17: An apparatus for global navigation satellite system (GNSS) measurement handling for precise positioning of a GNSS device, the apparatus comprising: means for receiving GNSS correction data from a correction data source; means for determining, for a set of GNSS measurements performed by the GNSS device and corresponding to a measurement epoch, a respective standard deviation of pre-fit residuals of one or more GNSS measurement types of the set of GNSS measurements, the one or more GNSS measurement types comprising: pseudorange (PR) measurements, carrier phase (CP) measurements, Doppler (DR) measurements, or any combination thereof; means for determining at least one conditional trigger is met based on a comparison of the respective standard deviation of pre-fit residuals of the one or more GNSS measurement types with a respective threshold; means for, responsive to determining the at least one conditional trigger is met, modifying how a positioning engine processes one or more measurements of the set of GNSS measurements; and means for determining a position estimate of the GNSS device based at least in part on a result of the modified processing of the one or more measurements by the positioning engine and the GNSS correction data.

Clause 18: The apparatus of clause 17, wherein the means for modifying how the positioning engine processes one or more measurements of the set of GNSS measurements comprises means for using only a subset of the set of GNSS measurements for a measurement update performed by the positioning engine, wherein the subset of the set of GNSS measurements excludes all measurements of at least one measurement type of the one or more GNSS measurement types.

Clause 19: The apparatus of any one of clauses 17-18 wherein the means for modifying how the positioning engine processes one or more measurements of the set of GNSS measurements comprises: means for using a scale factor (SF) to modify a processing threshold; means for comparing, for each measurement of the one or more measurements, a respective pre-fit residual of the measurement with the modified processing threshold; and means for excluding at least one of the one or more measurements from a measurement update performed by the positioning engine, responsive to the comparison of the respective pre-fit residual of the measurement with the modified processing threshold.

Clause 20: The apparatus of any one of clauses 17-19 wherein the means for modifying how the positioning engine processes one or more measurements of the set of GNSS measurements comprises: means for comparing, for each measurement of the one or more measurements, a respective pre-fit residual of the measurement with a weighting threshold; and means for changing a respective weight of at least one of the one or more measurements used in a measurement update performed by the positioning engine, responsive to the comparison of the respective pre-fit residual of the measurement with the weighting threshold.

Clause 21: The apparatus of clause 20 wherein the weighting threshold comprises a processing threshold modified by a scale factor (SF).

Clause 22: The apparatus of any one of clauses 20-21 wherein the means for changing the respective weight of the at least one of the one or more measurements comprises means for increasing a respective uncertainty corresponding to the at least one of the one or more measurements.

Clause 23: The apparatus of any one of clauses 17-22 wherein the GNSS correction data comprises real-time kinematic (RTK) or precise point positioning (PPP) correction data.

Clause 24: The apparatus of any one of clauses 17-23 wherein the respective threshold is based at least in part on: the one or more GNSS measurement types, whether the GNSS correction data comprises RTK correction data or PPP correction data, an environment, a measurement uncertainty, or any combination thereof.

Clause 25: A non-transitory computer-readable medium storing instructions for global navigation satellite system (GNSS) measurement handling for precise positioning of a GNSS device, the instructions comprising code for: receiving, at the GNSS device, GNSS correction data from a correction data source; determining, for a set of GNSS measurements performed by the GNSS device and corresponding to a measurement epoch, a respective standard deviation of pre-fit residuals of one or more GNSS measurement types of the set of GNSS measurements, the one or more GNSS measurement types comprising: pseudorange (PR) measurements, carrier phase (CP) measurements, Doppler (DR) measurements, or any combination thereof; determining at least one conditional trigger is met based on a comparison of the respective standard deviation of pre-fit residuals of the one or more GNSS measurement types with a respective threshold; responsive to determining the at least one conditional trigger is met, modifying how a positioning engine processes one or more measurements of the set of GNSS measurements; and determining a position estimate of the GNSS device based at least in part on a result of the modified processing of the one or more measurements by the positioning engine and the GNSS correction data.

Clause 26: The computer-readable medium of clause 25, wherein the code for modifying how the positioning engine processes one or more measurements of the set of GNSS measurements comprises code for using only a subset of the set of GNSS measurements for a measurement update performed by the positioning engine, wherein the subset of the set of GNSS measurements excludes all measurements of at least one measurement type of the one or more GNSS measurement types.

Clause 27: The computer-readable medium of any one of clauses 25-26 wherein the code for modifying how the positioning engine processes one or more measurements of the set of GNSS measurements comprises code for: using a scale factor (SF) to modify a processing threshold; for each measurement of the one or more measurements, comparing a respective pre-fit residual of the measurement with the modified processing threshold; and responsive to the comparison of the respective pre-fit residual of the measurement with the modified processing threshold, excluding at least one of the one or more measurements from a measurement update performed by the positioning engine.

Clause 28: The computer-readable medium of any one of clauses 25-27 wherein the code for modifying how the positioning engine processes one or more measurements of the set of GNSS measurements comprises code for: for each measurement of the one or more measurements, comparing a respective pre-fit residual of the measurement with a weighting threshold; and responsive to the comparison of the respective pre-fit residual of the measurement with the weighting threshold, changing a respective weight of at least one of the one or more measurements used in a measurement update performed by the positioning engine.

Clause 29: The computer-readable medium of clause 28 wherein the weighting threshold comprises a processing threshold modified by a scale factor (SF).

Clause 30: The computer-readable medium of any one of clauses 28-29 wherein the code for changing the respective weight of the at least one of the one or more measurements comprises code for increasing a respective uncertainty corresponding to the at least one of the one or more measurements.

Clause 31: The computer-readable medium of any one of clauses 25-30 wherein the GNSS correction data comprises real-time kinematic (RTK) or precise point positioning (PPP) correction data.

Clause 32: The computer-readable medium of any one of clauses 25-31 wherein the respective threshold is based at least in part on: the one or more GNSS measurement types, whether the GNSS correction data comprises RTK correction data or PPP correction data, an environment, a measurement uncertainty, or any combination thereof.

What is claimed is:

1. A method of global navigation satellite system (GNSS) measurement handling for precise positioning of a GNSS device, the method comprising:
receiving, at the GNSS device, GNSS correction data from a correction data source;
determining, for a set of GNSS measurements performed by the GNSS device and corresponding to a measurement epoch, a respective standard deviation of pre-fit residuals of one or more GNSS measurement types of the set of GNSS measurements, the one or more GNSS measurement types comprising:
pseudorange (PR) measurements,
carrier phase (CP) measurements,
Doppler (DR) measurements, or
any combination thereof;
determining at least one conditional trigger is met based on a comparison of the respective standard deviation of pre-fit residuals of the one or more GNSS measurement types with a respective threshold;
responsive to determining the at least one conditional trigger is met, modifying how a positioning engine processes one or more measurements of the set of GNSS measurements; and
determining a position estimate of the GNSS device based at least in part on a result of the modified processing of the one or more measurements by the positioning engine and the GNSS correction data.

2. The method of claim 1, wherein modifying how the positioning engine processes one or more measurements of the set of GNSS measurements comprises using only a subset of the set of GNSS measurements for a measurement update performed by the positioning engine, wherein the subset of the set of GNSS measurements excludes all measurements of at least one measurement type of the one or more GNSS measurement types.

3. The method of claim 1, wherein modifying how the positioning engine processes one or more measurements of the set of GNSS measurements comprises:
using a scale factor (SF) to modify a processing threshold;
for each measurement of the one or more measurements, comparing a respective pre-fit residual of the measurement with the modified processing threshold; and
responsive to the comparison of the respective pre-fit residual of the measurement with the modified processing threshold, excluding at least one of the one or more measurements from a measurement update performed by the positioning engine.

4. The method of claim 1, wherein modifying how the positioning engine processes one or more measurements of the set of GNSS measurements comprises:
for each measurement of the one or more measurements, comparing a respective pre-fit residual of the measurement with a weighting threshold; and
responsive to the comparison of the respective pre-fit residual of the measurement with the weighting threshold, changing a respective weight of at least one of the one or more measurements used in a measurement update performed by the positioning engine.

5. The method of claim 4, wherein the weighting threshold comprises a processing threshold modified by a scale factor (SF).

6. The method of claim 4, wherein changing the respective weight of the at least one of the one or more measurements comprises increasing a respective uncertainty corresponding to the at least one of the one or more measurements.

7. The method of claim 1, wherein the GNSS correction data comprises real-time kinematic (RTK) or precise point positioning (PPP) correction data.

8. The method of claim 1, wherein the respective threshold is based at least in part on:
the one or more GNSS measurement types,
whether the GNSS correction data comprises RTK correction data or PPP correction data,
an environment,
a measurement uncertainty, or
any combination thereof.

9. A GNSS device for global navigation satellite system (GNSS) measurement handling for precise positioning of a GNSS device, the GNSS device comprising:
one or more transceivers;
one or more memories; and
one or more processors communicatively coupled with the one or more transceivers and the one or more memories, wherein the one or more processors are configured to:
receive, via the one or more transceivers, GNSS correction data from a correction data source;
determine, for a set of GNSS measurements performed by the GNSS device and corresponding to a measurement epoch, a respective standard deviation of pre-fit residuals of one or more GNSS measurement types of the set of GNSS measurements, the one or more GNSS measurement types comprising:
pseudorange (PR) measurements,
carrier phase (CP) measurements,
Doppler (DR) measurements, or
any combination thereof;
determine at least one conditional trigger is met based on a comparison of the respective standard deviation of pre-fit residuals of the one or more GNSS measurement types with a respective threshold;
responsive to determining the at least one conditional trigger is met, modifying how a positioning engine processes one or more measurements of the set of GNSS measurements; and
determine a position estimate of the GNSS device based at least in part on a result of the modified processing of the one or more measurements by the positioning engine and the GNSS correction data.

10. The GNSS device of claim 9, wherein to modify how the positioning engine processes one or more measurements of the set of GNSS measurements the one or more processors are configured to use only a subset of the set of GNSS measurements for a measurement update performed by the positioning engine, wherein the subset of the set of GNSS measurements excludes all measurements of at least one measurement type of the one or more GNSS measurement types.

11. The GNSS device of claim 9, wherein, to modify how the positioning engine processes one or more measurements of the set of GNSS measurements, the one or more processors are configured to:
use a scale factor (SF) to modify a processing threshold;
for each measurement of the one or more measurements, compare a respective pre-fit residual of the measurement with the modified processing threshold; and
responsive to the comparison of the respective pre-fit residual of the measurement with the modified processing threshold, exclude at least one of the one or more measurements from a measurement update performed by the positioning engine.

12. The GNSS device of claim 9, wherein, to modify how the positioning engine processes one or more measurements of the set of GNSS measurements, the one or more processors are configured to:
for each measurement of the one or more measurements, compare a respective pre-fit residual of the measurement with a weighting threshold; and
responsive to the comparison of the respective pre-fit residual of the measurement with the weighting threshold, change a respective weight of at least one of the one or more measurements used in a measurement update performed by the positioning engine.

13. The GNSS device of claim 12, wherein the weighting threshold comprises a processing threshold modified by a scale factor (SF).

14. The GNSS device of claim 12, wherein, to change the respective weight of the at least one of the one or more measurements, the one or more processors are configured to increase a respective uncertainty corresponding to the at least one of the one or more measurements.

15. The GNSS device of claim 9, wherein the GNSS correction data comprises real-time kinematic (RTK) or precise point positioning (PPP) correction data.

16. The GNSS device of claim 9, wherein the respective threshold is based at least in part on:
the one or more GNSS measurement types,
whether the GNSS correction data comprises RTK correction data or PPP correction data,
an environment,
a measurement uncertainty, or
any combination thereof.

17. An apparatus for global navigation satellite system (GNSS) measurement handling for precise positioning of a GNSS device, the apparatus comprising:
means for receiving GNSS correction data from a correction data source;
means for determining, for a set of GNSS measurements performed by the GNSS device and corresponding to a measurement epoch, a respective standard deviation of pre-fit residuals of one or more GNSS measurement types of the set of GNSS measurements, the one or more GNSS measurement types comprising:
pseudorange (PR) measurements,
carrier phase (CP) measurements,
Doppler (DR) measurements, or
any combination thereof;
means for determining at least one conditional trigger is met based on a comparison of the respective standard deviation of pre-fit residuals of the one or more GNSS measurement types with a respective threshold;
means for, responsive to determining the at least one conditional trigger is met, modifying how a positioning engine processes one or more measurements of the set of GNSS measurements; and
means for determining a position estimate of the GNSS device based at least in part on a result of the modified processing of the one or more measurements by the positioning engine and the GNSS correction data.

18. The apparatus of claim 17, wherein the means for modifying how the positioning engine processes one or more measurements of the set of GNSS measurements comprises means for using only a subset of the set of GNSS measurements for a measurement update performed by the positioning engine, wherein the subset of the set of GNSS measurements excludes all measurements of at least one measurement type of the one or more GNSS measurement types.

19. The apparatus of claim 17, wherein the means for modifying how the positioning engine processes one or more measurements of the set of GNSS measurements comprises:
means for using a scale factor (SF) to modify a processing threshold;
means for comparing, for each measurement of the one or more measurements, a respective pre-fit residual of the measurement with the modified processing threshold; and
means for excluding at least one of the one or more measurements from a measurement update performed by the positioning engine, responsive to the comparison of the respective pre-fit residual of the measurement with the modified processing threshold.

20. The apparatus of claim 17, wherein the means for modifying how the positioning engine processes one or more measurements of the set of GNSS measurements comprises:
means for comparing, for each measurement of the one or more measurements, a respective pre-fit residual of the measurement with a weighting threshold; and
means for changing a respective weight of at least one of the one or more measurements used in a measurement update performed by the positioning engine, responsive to the comparison of the respective pre-fit residual of the measurement with the weighting threshold.
